(19) United States
(12) Patent Application Publication
(10) Pub. No.: US 2010/0065058 A1
(43) Pub. Date: Mar. 18, 2010

(54) Full face respirator mask

(75) Inventors: William Dean Ungar, Torrance, CA (US); Terry L. Grimsley, Torrance, CA (US); Bernard Mishkin, Los Angeles, CA (US)

Correspondence Address: Charles H. Schwartz;Moldex-Metric, Inc., 10111 W. Jefferson Blvd., Culver City, CA, 90232, US

(73) Assignee: Moldex-Metric, Inc.

(21) Appl. No.: 12/284,133

(22) Filed: Sep. 18, 2008

(51) Int. Cl. A62B 18/08

(52) U.S. Cl. 128/206.24

(57) ABSTRACT

A full face respirator mask includes a rigid plastic integrally molded lens member that has a transparent viewing portion and a central integrally molded port portion. The central port portion is disposed beneath the viewing portion when the mask is viewed from a front elevation. An integrally molded exhalation port is disposed in the central port portion of the rigid plastic lens. First and second air intake ports are disposed in the integrally molded lens member to either side of the central port portion of the rigid plastic lens member. Each air intake port is adapted to support either a plug member to close off the air intake ports or a filter cartridge to filter air passing through the air intake port. An integrally molded portion forming a connector is located within the central port portion of the integrally molded lens member to receive either an outside supply of air when the air intake ports each hold a plug member to close off the air intake ports or a plug member to close off the connector when the air intake ports support the filter cartridges. A face seal is attached to the lens member at an outside edge of the lens member and is adapted to mate with the wearer's face, and the face seal is attached by overmolding the face seal around the outside edge of the lens member to form an adhesive bond between the face seal and the lens member.

### BACKGROUND OF THE INVENTION

The present invention relates generally to a full face respirator mask, and specifically to such a mask for use in contaminated environments where there may be toxic materials present in the air.

For example, such full face respirator masks may be used by firefighters, military or any industry where a clean supply of air is necessary since the surrounding environment may be contaminated with toxic materials. In addition to supplying this clean air supply, the full face respirator mask also provides a seal around the entire face with a flexible facepiece to protect both the eyes and the face from the potentially harmful environment. This type of full face mask typically includes a transparent face shield forming a lens member and provision for either replaceable filter cartridges so as to filter out contaminants in the surrounding air, or alternatively may include a threaded connector to provide for means for accepting a supply of air from a clean source such as an air canister. The mask also would include an exhalation port so that expelled air can pass out of the mask into the surrounding air.

The full face respirator mask may also include a nose cup provided around the nose and mouth area of the user to assist in directing the flow of input air into and out of the face mask. The nose cup also assists in directing the expired air through the exhalation port, thereby reducing the buildup of carbon dioxide within the mask, and also preventing fogging of the facemask lens.

It is also desirable to provide as large a size for the lens member as possible, so as to increase the visual range of the wearer when viewing through the mask. For example, various attachment devices or connecting devices that form separate portions can sometimes impinge on the size of the lens member of the mask. It is therefore desirable to reduce or if possible eliminate some of the traditional connecting members. It would also be desirable to minimize as much as possible the structure of the mask by eliminating unnecessary members and to simplify the manufacture of the mask. It would therefore be desirable to incorporate within the lens member itself as much as possible the various connecting portions that cooperate with the filter cartridges or canister or any other means for providing connections to the mask of a clean supply of outside air.

### SUMMARY OF THE INVENTION

The present invention incorporates a number of unique features that simplify the construction of the mask and reduce the cost while maintaining a lightweight versatile full face respirator mask. The features include a central exhalation area of the lens member that integrates an exhalation valve and a connector portion, generally referred to as a DIN screw connector, as an integral part of the overall molded lens member. The prior art typically has a separate member that is attached to the lens in a central position with a gasket seal. Applicants' unique integrally molded lens member makes it possible to dispense with the prior art additional interchangeable parts and have one model of mask that is adaptable to a variety of components such as supplied air from a single central cartridge or powered air, both through the central DIN connector. By incorporating this integrally molded structure, and specifically the exhaust valve mount and the DIN connector into the molded lens, these features are achieved with a number of benefits. These benefits include no added cost of separate parts, no cost to inventory additional parts and no associated labor to install the separate parts. Also, there is no risk of air leakage from the gasket seal.

As indicated above, the face mask also includes a nose cup to assist in directing the flow of air into and out of the face mask. When used in conjunction with the DIN threaded connector to an outside air supply, the prior art typically uses a separate air deflector part added to the assembly hub of the threaded fitting. The deflector's purpose is to deflect and guide incoming air towards air ports inside the mask. In addition, a separate part featuring the air ports may be required with the prior art masks. In the present invention, the air deflector and air ports are incorporated in the molded structure of the nose cup so that both features can be achieved with the following benefits: no added cost of separate parts, no cost to inventory the additional parts and no associated labor to install the parts.

In the prior art, typically, the lens member and the surrounding flexible facepiece are held together securely using a screw-together plastic clamp yoke. In the present invention, the rubber-like face seal forming the flexible facepiece is overmolded directly to the lens member to provide for a strong adhesive bond between the two parts. Normally, this would not be possible, since the lens member of the prior art typically has a scratch resistant surface coating of a silicone based material. The silicone based material prevents the adhesive bond.

The present invention incorporates a different material for the scratch resistance coating that is deposited on the surface of the lens. This material provides for the scratch resistance that is typically achieved with silicone, and this material is unique to Applicants' structure. This material allows for the overmolding to achieve the desired adhesive bond. The scratch resistant material that is used in the present invention is melamine based to allow for the overmolding and provide for the adhesion between the facepiece and the lens member. This simplified overmolded structure for the facemask provides for the following benefits: no added cost of clamp and screw hardware, no cost to inventory these parts and no associated labor to install the parts.

Although there have been facemasks which do incorporate overmolding, these facemasks do not use unique lens member of the present invention. Also, these facemasks do not use the melamine based coating to provide for scratch resistance and yet still allow for the overmolding of the facepiece to the lens member. In addition to the use of the melamine based coating, Applicants' invention also may incorporate mechanical means to further increase the adhesive bond between the flexible facepiece and the lens member. These mechanical means may include a textured outer edge to increase the surface area between the facepiece and the lens member and an undercut at the edge of the lens member to produce a shelf for the flexible face piece to rest against to resist forces that could separate the facepiece from the lens member. The textured outer edge may be produced by etching, such as plasma or chemical etching or abrading by mechanical grinding.

A clearer understanding of the present invention will be had with reference to the following description and drawings as well as the appended claims at the end of the application.

### BRIEF DESCRIPTION OF THE DRAWINGS

FIG. 1 shows a front perspective view of a full face respirator mask according to the principles of the present invention.

FIG. 1(a) is a cross sectional view of the mask taken along lines (a)-(a) in FIG. 1.

FIG. 2 is a back perspective view of the respirator mask shown in FIG. 1.

FIG. 3 is a front view of the lens member portion of the respirator mask of FIG. 1.

FIG. 4 is a back view of the lens member portion of the respirator mask of FIG. 1.

FIG. 5 is a side view of the lens member portion of the respirator mask of FIG. 1.

FIG. 6 is a perspective view of the nose cup portion of the respirator mask of FIG. 1.

FIG. 7 is a front view of the nose cup of FIG. 6.

FIG. 8 is a back view of the nose cup of FIG. 6.

### DETAILED DESCRIPTION OF THE DRAWINGS

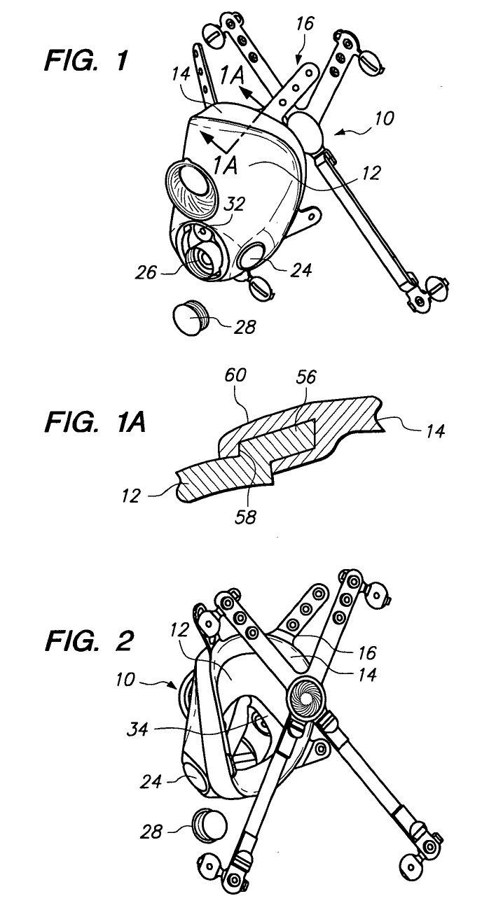

As shown in FIGS. 1 and 2, a respirator mask (10) is a full face respirator mask that provides coverage of the entire area of a wearer's face, including coverage of the eyes, the nose, and the mouth. The respirator mask (10) includes a rigid plastic lens (12) surrounded with a flange (14) which flange (14) provides for a seal to the face of the wearer. The flange (14) prevents various exterior vapors, fumes, dusts, mists and other irritants or harmful gases and fluids from coming in contact with the eyes, the nose, and the mouth of the wearer's face. A harness assembly (16) keeps the flange (14) in proper contact with the wearer's face to provide for the above results. As indicated above, the lens member (12) is rigid, and the flange (14) is relatively soft to provide for the proper sealing to the wearer's face.

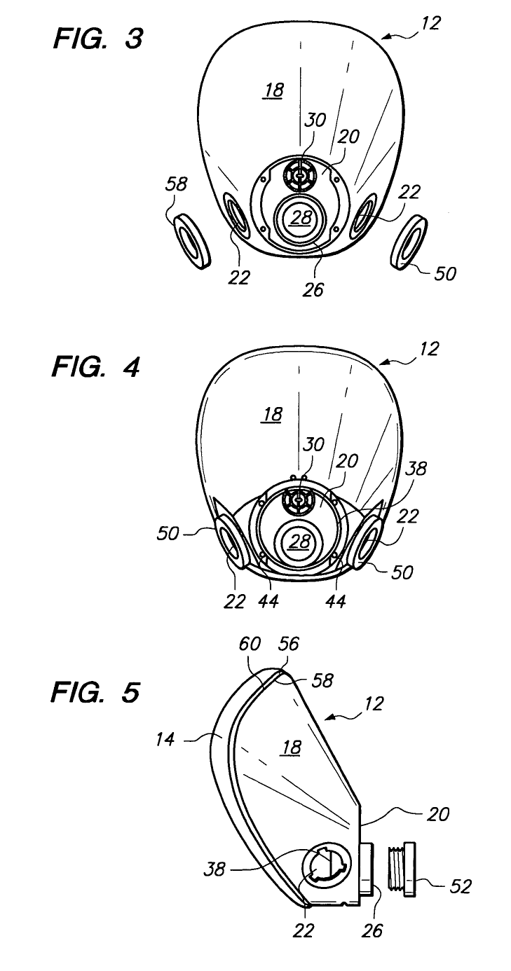

As can be seen in further detail in FIGS. 3-5, the lens (12) includes a transparent viewing portion (18) and a number of ports. Specifically, the lens member (12) includes an integrally molded central port area (20) and side port areas (22). The side ports (22) provide for air intake ports and specifically are designed to accommodate canister filters (50), shown in FIGS. 3 and 4, which interlock with the port openings (22) and provide for the intake of air through the filter canisters.

If the filter canisters (50) are used for the supply of intake air, then the intake ports (22) may be closed off with plugs (24), as shown in FIGS. 1 and 2. Alternatively, powered air can be supplied to the mask through a central port and specifically through a port connector (26). This is shown most clearly in FIG. 1. If, however, air is being supplied through the ports (22), using filtered canisters (50), then port (26) may be closed off with a plug (28), as shown in FIGS. 1, 2, and 3. It can be seen, therefore, that air can be supplied to the respirator mask, either through the ports (22) when filter canisters (50) are used in a known way, or through the connector (26) if it is desired to provide for a central supply of air to the respirator mask. In either case, one or the other of the ports would be closed off to accommodate the desired result.

In addition to the above ports (22) and (26), the port area (20) also includes an exhalation port (30). Air that is exhaled by the wearer therefore can exit through the exhalation port (30), and with the proper valve member insuring that no air would enter through the exhalation port (30). This valve member can be seen in more detail in FIG. 1, and is shown as a flap member (32), so that the port (30) and flap (32) form a standard button valve.

As can be seen in the drawings, the lens member (12) is integrally molded to include the central port area (20) of the lens, which integrates an exhalation valve port (30) and a connector port (26). The connector (26) is typically formed as a screw connector generally referred to as a DIN screw connector. All of these structures are integrally formed and integrated as part of the overall lens member. This integrated design allows for the integrally molded lens member to eliminate additional interchangeable parts, and to have one model of respirator mask that is adaptable to other components to provide supplied air through twin side canisters, powered air through a central connector or supplied air through a single central cartridge. In other words, the port (26) can be used to receive powered air, or could be used to receive air through a central single cartridge (52) shown in FIG. 5, thereby eliminating the use of filter cartridges (50) attached to the ports (22).

In some types of respirators, the use of the DIN connector may not be necessary. The connector (26) may then be closed off by a plug. Alternately, the connector (26) may be eliminated and the area integrally formed with the rest of the lens member (12) as a solid surface.

All of this integrated structure provides for a very versatile design for the respirator mask. This integrated structure allows for all of the features to be achieved without the added cost of separate parts, and thereby the elimination of the need to inventory and manufacture these additional parts. This integrated structure also provides for the ability to have all the parts integrally molded as part of the lens member, so that there is no need to have additional labor to attach parts together. This integrated structure further eliminates the risk of air leakage from a sealing mechanism that would normally incorporate a gasket to seal these additional parts within the rigid lens.

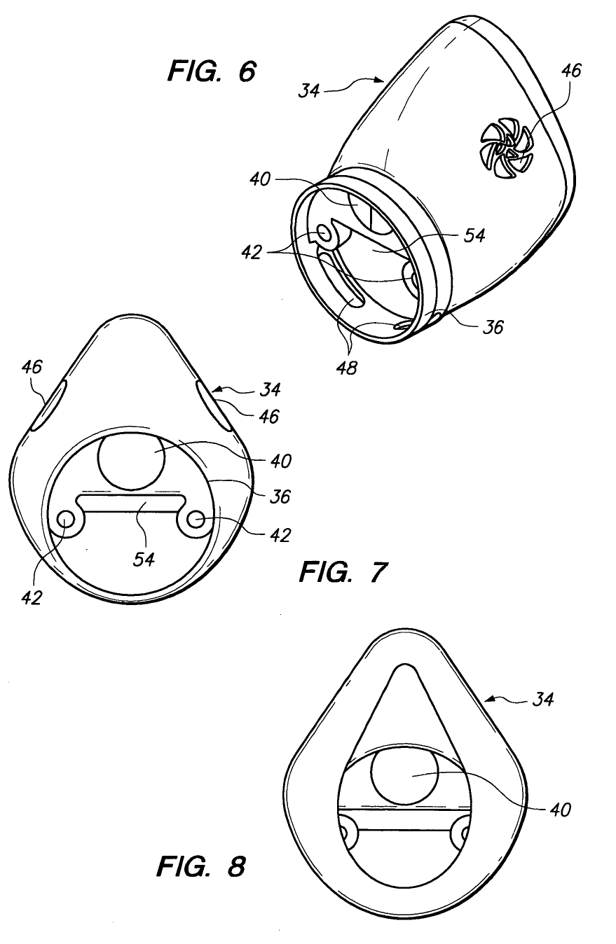

As shown in FIG. 2, the respirator mask (10) also incorporates a nose cup (34). This nose cup (34) is shown in more detail in FIGS. 6-8. The nose cup (34) is made of a soft, rubber-like material to fit over the nose and mouth of the wearer, and is located within the respirator mask, and specifically within the lens member (12) of the mask. A front portion (36) of the nose cup (34) forms an outer flange that fits over an inner flange (38), located within and integrally molded as part of the lens member (12). This can be seen in FIGS. 4 and 5.

The front of the nose cup (34) therefore, is located immediately behind the central port area (20) of the lens member (12) and the nose cup (34) has portions that complement those integrated portions of the central port area (20). For example, the nose cup includes an opening (40) that corresponds with the exhalation valve port (30) of the lens member. In addition, to help lock the nose cup in position within the lens (12), openings (42) in the nose cup fit over corresponding pins (44) integrally molded as part of the lens member (12).

The nose cup (34) also includes air intake ports (46) located on both sides of the cup at an upper position. Also, slotted air intake ports (48) are located within the forward flange portion (36), but behind the area where the flange (36) fits over the corresponding inner flange (38) of the lens member. The openings (46) serve as air intake inhalation ports and each would typically incorporate a flap member in the interior portion of the nose cup to form a button type valve. This allows for the inhalation of air located within the lens member of the respirator mask to be directed to the nose and mouth of the wearer.

Typically the operation of the respirator mask would be as follows. Assuming the arrangement where the front opening (26) is closed off with the plug (28), and air enters the mask through the side ports (24) fitted with filter canisters (50). The intake air would pass through the filter canisters fitted to the openings (24), and through the openings (24) to the interior of the lens member and up the sides of the lens member and through the openings (46) that form inhalation valves and into the nose cup. The intake air may now be inhaled by the wearer. Exhaled air would exit directly through the opening (40) in the nose cup and through the exhalation valve (30) in the lens portion (12).

Alternatively, the openings (24) may be closed as shown by the plugs (24) in place in FIGS. 1 and 2, and air could enter through the opening (26) through using either a central canister (52) shown in FIG. 5, or powered air through the connector (26). In either case, the air would be entering through the opening (26) and as the air enters the opening (26), it is directed downward by a front deflecting portion (54) of the nose cup to the slotted ports (46). The intake air is again directed to the side of the nose cup and through the inhalation valves (46) into the interior of the nose cup to be inhaled by the wearer of the respirator mask. The exhaled air would be essentially the same as before.

As can be seen in the above structure, the nose cup does not incorporate a separate air deflector that is usually provided for in the prior art structures. The deflector (54) is incorporated within the nose cup itself to deflect and guide the incoming air towards the air ports (48) that are incorporated within the nose cup. All of these features are therefore achieved with no added cost for separate parts, no cost to inventory additional parts, and no associated labor to install these parts.

As can be seen in FIGS. 1 and 2 and also in FIG. 5, the outer flange (14) is overmolded directly to the lens to provide for a strong adhesive bond between the two parts. FIG. 1(a) is a cross sectional view taken along line (a)-(a) of FIG. 1 and illustrates in more detail the overmolded structure. This overmolding is in distinction to the prior art where the lens and surrounding facepiece are held together securely using a screw together plastic clamp yoke.

Normally it would not be possible to overmold the flange to the lens member, since the lens member typically has a scratch resistant surface coating of a silicone material that prevents a strong adhesive bond between the two parts. The present invention, however, includes the use of a different surface coating to provide for the scratch resistance that is typically achieved with silicone. Applicants specifically provide for the use of a melamine based thermoformable scratch resistant coating, an example of which is manufactured by Film Specialties, Inc. under the trademark “FormGard™.” The melamine based material provides for the scratch resistance but still allows for a strong adhesive bond between the overmolded flange and the lens member.

In addition to the use of the melamine based material, the strong adhesive bond between the flange and the lens is also enhanced by the use of a shelf portion (56) located around the circumference of the lens. This shelf portion may be further undercut at position (58) and provide for a further bond to prevent the flange from being pulled off the lens. Also, the lip portion (56) surrounding area may have a rougher textured surface (60) to provide for a greater surface area and adhesion between the overmolded flange and the lens. The textured surface (60) may be produced by etching, such as plasma or chemical etching or abrading by mechanical grinding.

Although the invention has been described with reference to particular structure, it will be appreciated that various adaptations and modifications may be made and the invention is only to be limited by the appended claims.

We claim:

1. An integrally molded lens member for use with a flexible facepiece of a full face respiratory mask, the lens member being rigid relative to the flexible facepiece, the integrally molded lens member including a pair of cheek portions and with each cheek portion formed with an aperture and structure around the aperture to mate with and hold either a filter cartridge or a plug member to close off the aperture, and a central portion integrally molded as part of the lens member having a first integrally molded portion forming an exhalation valve, and a second integrally molded portion forming a connector to receive either an outside supply of air when the cheek apertures each hold a plug member to close off the cheek apertures or a plug member to close off the connector when the cheek aperture hold the filter cartridges.

2. The integrally molded lens member of claim 1 wherein the connector located in the central portion is integrally molded to form a DIN screw connector.

3. The integrally molded lens member of claim 1 wherein a flexible facepiece is attached to the lens member at an outside edge of the lens member and is adapted to mate with a wearer's face, and wherein the flexible facepiece is attached by overmolding the flexible facepiece around the outside edge of the lens member to form an adhesive bond between the flexible facepiece and the lens member.

4. The integrally molded lens member of claim 3 wherein the outside edge of the lens member is provided with a textured outer edge to increase the surface area between the flexible facepiece and the lens member to enhance the adhesive bond.

5. The integrally molded lens member of claim 3 wherein the outside edge of the lens member is provided with an undercut at the edge of the lens member to produce a shelf for the flexible face piece to rest against to resist forces that could separate the facepiece from the lens member.

6. The integrally molded lens member of claim 3 wherein a scratch resistant material is applied to the lens member prior to the overmolding of the flexible facepiece to the outside edge of the lens member and with the scratch resistant material being melamine based to allow for the overmolding and provide for the adhesion between the flexible facepiece and the lens member.

7. The integrally molded lens member of claim 6 wherein the outside edge of the lens member is provided with a textured outer edge to increase the surface area between the flexible facepiece and the lens member to enhance the adhesive bond.

8. The integrally molded lens member of claim 6 wherein the outside edge of the lens member is provided with an undercut at the edge of the lens member to produce a shelf for the flexible face piece to rest against to resist forces that could separate the facepiece from the lens member.

9. The integrally molded lens member of claim 1 additionally including a nose cup to assist in directing the flow of air into and out of the face mask and with the nose cup located within the integrally molded lens member and mounted around the central portion integrally molded as part of the lens member and to communicate directly with the exhalation valve to provide for the direct exit of exhaust air and to communicate with the connector to receive an outside supply of air when the cheek apertures each hold a plug member to close off the cheek apertures.

10. The integrally molded lens member of claim 9 wherein the nose cup is integrally molded to include an air deflector portion and air ports and with the deflector portion deflecting and guiding incoming air towards the air ports.

11. The integrally molded lens member of claim 10 wherein the air deflector portion is configured to deflect the outside supply of air from the connector downward to the air ports located at a bottom portion of the nose cup to have the air supply pass between the nose cup and the lens member and to reenter an upper portion of the nose cup.

12. A full face respirator mask comprising a flexible facepiece adapted to mate with a wearer's face and including a molded lens member, the lens member being rigid relative to the flexible facepiece, the mask including a lens member having a pair of cheek portions and with each cheek portion formed with an aperture and structure around the aperture to mate with and hold either a filter cartridge or a plug member to close off the aperture, a central portion of the lens member having a first portion forming an exhalation valve, and a second portion forming a connector to receive either an outside supply of air when the cheek apertures each hold a plug member to close off the cheek apertures or a plug member to close off the connector when the cheek aperture hold the filter cartridges, the flexible facepiece attached to the lens member at an outside edge of the lens member and adapted to mate with a wearer's face, and wherein the flexible facepiece is attached to the lens member by overmolding the flexible facepiece around an outside edge of the lens member to form an adhesive bond between the flexible facepiece and the lens member, and a scratch resistant material applied to the lens member prior to the overmolding of the flexible facepiece to the outside edge of the lens member and with the scratch resistant material being melamine based to allow for the overmolding and provide for the adhesion between the flexible facepiece and the lens member.

13. The respirator mask of claim 12 wherein the outside edge of the lens member is provided with a textured outer edge to increase the surface area between the flexible facepiece and the lens member to enhance the adhesive bond.

14. The respirator mask of claim 12 wherein the outside edge of the lens member is provided with an undercut at the edge of the lens member to produce a shelf for the flexible face piece to rest against to resist forces that could separate the facepiece from the lens member.

15. The respirator mask of claim 12 wherein the central portion is integrally molded as part of the lens member to have the first portion forming an integrally molded exhalation valve, and the second portion forming an integrally molded connector to receive either the outside supply of air when the cheek apertures each hold a plug member to close off the cheek apertures or the plug member to close off the connector when the cheek aperture hold the filter cartridges.

16. The respirator mask as defined in claim 15 wherein the connector located in the central portion is integrally molded to form a DIN screw connector.

17. The respirator mask of claim 12 additionally including a nose cup to assist in directing the flow of air into and out of the face mask and with the nose cup located within the lens member and mounted around the central portion of the lens member and to communicate directly with the exhalation valve to provide for the direct exit of exhaust air and to communicate with the connector to receive an outside supply of air when the cheek apertures each hold a plug member to close off the cheek apertures.

18. The respirator mask of in claim 17 wherein the nose cup is integrally molded to include an air deflector portion and air ports and with the deflector portion deflecting and guiding incoming air towards the air ports.

19. The respirator mask of claim 18 wherein the air deflector portion is configured to deflect the outside supply of air from the connector downward to the air ports located at a bottom portion of the nose cup to have the air supply pass between the nose cup and the lens member and to reenter an upper portion of the nose cup.

20. A full face respirator mask that includes a rigid plastic integrally molded lens member that has a transparent viewing portion and a central integrally molded port portion, the central port portion being disposed beneath the viewing portion when the mask is viewed from a front elevation, an integrally molded exhalation port disposed in the central port portion of the rigid plastic lens, first and second air intake ports disposed in the integrally molded lens member to either side of the central port portion of the rigid plastic lens member and each air intake port adapted to support either a plug member to close off the air intake ports or a filter cartridge to filter air passing through the air intake port, an integrally molded portion forming a connector located within the central port portion of the integrally molded lens member to receive either an outside supply of air when the air intake ports each hold a plug member to close off the air intake ports or a plug member to close off the connector when the air intake ports support the filter cartridges, and a face seal disposed on the full face respirator mask to seal the respirator over a wearer's eyes, nose, and mouth.

21. The full face respirator mask of claim 20 wherein the connector located in the central port portion is integrally molded to form a DIN screw connector.

22. The full face respirator mask of claim 20 wherein the face seal is attached to the lens member at an outside edge of the lens member and is adapted to mate with the wearer's face, and wherein the face seal is attached by overmolding the face seal around the outside edge of the lens member to form an adhesive bond between the face seal and the lens member.

23. The full face respirator mask of claim 22 wherein the outside edge of the lens member is provided with a textured outer edge to increase the surface area between the face seal and the lens member to enhance the adhesive bond.

24. The full face respirator mask of claim 22 wherein the outside edge of the lens member is provided with an undercut at the edge of the lens member to produce a shelf for the face seal to rest against to resist forces that could separate the face seal from the lens member.

25. The full face respirator mask of claim 22 wherein a scratch resistant material is applied to the lens member prior to the overmolding of the face seal to the outside edge of the lens member and with the scratch resistant material being melamine based to allow for the overmolding and provide for the adhesion between the face seal and the lens member.

26. The full face respirator mask of claim 25 wherein the outside edge of the lens member is provided with a textured outer edge to increase the surface area between the face seal and the lens member to enhance the adhesive bond.

27. The full face respirator mask of claim 25 wherein the outside edge of the lens member is provided with an undercut at the edge of the lens member to produce a shelf for the face seal to rest against to resist forces that could separate the face seal from the lens member.

28. The full face respirator mask of claim 20 additionally including a nose cup to assist in directing the flow of air into and out of the face mask and with the nose cup located within the integrally molded lens member and mounted around the central port portion integrally molded as part of the lens member and to communicate directly with the exhalation port to provide for the direct exit of exhaust air and to communicate with the connector to receive an outside supply of air when the air intake ports each hold a plug member to close off the air intake ports.

29. The full face respirator mask of claim 28 wherein the nose cup is integrally molded to include an air deflector portion and nose cup intake ports and with the deflector portion deflecting and guiding incoming air towards the nose cup intake ports.

30. The full face respirator mask of claim 29 wherein the air deflector portion is configured to deflect the outside supply of air from the connector downward to the nose cup intake ports located at a bottom portion of the nose cup to have the air supply pass between the nose cup and the lens member and to reenter an upper portion of the nose cup.

31. A full face respirator mask that includes a rigid plastic lens member that has a transparent viewing portion and a central port portion, the central port portion being disposed beneath the viewing portion when the mask is viewed from a front elevation, an exhalation port disposed in the central port portion of the rigid plastic lens, first and second air intake ports disposed in the lens member to either side of the central port portion of the rigid plastic lens member and each air intake port adapted to support either a plug member to close off the air intake ports or a filter cartridge to filter air passing through the air intake port, a connector located within the central port portion of the lens member to receive either an outside supply of air when the air intake ports each hold a plug member to close off the air intake ports or a plug member to close off the connector when the air intake ports support the filter cartridges, and a face seal disposed on the full face respirator mask to seal the respirator over a wearer's eyes, nose, and mouth wherein the face seal is attached to the lens member at an outside edge of the lens member and is adapted to mate with the wearer's face, and wherein the face seal is attached by overmolding the face seal around the outside edge of the lens member to form an adhesive bond between the face seal and the lens member.

32. The full face respirator mask of claim 31 wherein the outside edge of the lens member is provided with a textured outer edge to increase the surface area between the face seal and the lens member to enhance the adhesive bond.

33. The full face respirator mask of claim 31 wherein the outside edge of the lens member is provided with an undercut at the edge of the lens member to produce a shelf for the face seal to rest against to resist forces that could separate the face seal from the lens member.

34. The full face respirator mask of claim 31 wherein a scratch resistant material is applied to the lens member prior to the overmolding of the face seal to the outside edge of the lens member and with the scratch resistant material being melamine based to allow for the overmolding and provide for the adhesion between the face seal and the lens member.

35. The full face respirator mask of claim 34 wherein the outside edge of the lens member is provided with a textured outer edge to increase the surface area between the face seal and the lens member to enhance the adhesive bond.

36. The full face respirator mask of claim 34 wherein the outside edge of the lens member is provided with an undercut at the edge of the lens member to produce a shelf for the face seal to rest against to resist forces that could separate the face seal from the lens member.

37. The full face respirator mask of claim 31 wherein the connector located in the central port portion is integrally molded to form a DIN screw connector.

38. The full face respirator mask of claim 31 additionally including a nose cup to assist in directing the flow of air into and out of the face mask and with the nose cup located within the lens member and mounted around the central port portion to communicate directly with the exhalation port to provide for the direct exit of exhaust air and to communicate with the connector to receive an outside supply of air when the air intake ports each hold a plug member to close off the air intake ports.

39. The full face respirator mask of claim 38 wherein the nose cup is integrally molded to include an air deflector portion and nose cup intake ports and with the deflector portion deflecting and guiding incoming air towards the nose cup intake ports.

40. The full face respirator mask of claim 39 wherein the air deflector portion is configured to deflect the outside supply of air from the connector downward to the nose cup intake ports located at a bottom portion of the nose cup to have the air supply pass between the nose cup and the lens member and to reenter an upper portion of the nose cup.

41. An integrally molded lens member for use with a flexible facepiece of a full face respiratory mask, the lens member being rigid relative to the flexible facepiece, the integrally molded lens member including a pair of cheek portions and with each cheek portion formed with an aperture and structure around the aperture to mate with and hold a filter cartridge, and a central portion integrally molded as part of the lens member having a first integrally molded portion forming an exhalation valve.

42. The integrally molded lens member of claim 41 where each cheek member may also include a plug member to close off the aperture when no cartridge is used and with the central portion including a second integrally molded portion forming a connector to receive either an outside supply of air when the cheek apertures each hold a plug member to close off the cheek apertures or a plug member to close off the connector when the cheek aperture hold the filter cartridges.

43. The integrally molded lens member of claim 41 wherein a flexible facepiece is attached to the lens member at an outside edge of the lens member and is adapted to mate with a wearer's face, and wherein the flexible facepiece is attached by overmolding the flexible facepiece around the outside edge of the lens member to form an adhesive bond between the flexible facepiece and the lens member.

44. The integrally molded lens member of claim 43 wherein the outside edge of the lens member is provided with a textured outer edge to increase the surface area between the flexible facepiece and the lens member to enhance the adhesive bond.

45. The integrally molded lens member of claim 43 wherein the outside edge of the lens member is provided with an undercut at the edge of the lens member to produce a shelf for the flexible face piece to rest against to resist forces that could separate the facepiece from the lens member.

46. The integrally molded lens member of claim 43 wherein a scratch resistant material is applied to the lens member prior to the overmolding of the flexible facepiece to the outside edge of the lens member and with the scratch resistant material being melamine based to allow for the overmolding and provide for the adhesion between the flexible facepiece and the lens member.

47. The integrally molded lens member of claim 46 wherein the outside edge of the lens member is provided with a textured outer edge to increase the surface area between the flexible facepiece and the lens member to enhance the adhesive bond.

48. The integrally molded lens member of claim 46 wherein the outside edge of the lens member is provided with an undercut at the edge of the lens member to produce a shelf for the flexible face piece to rest against to resist forces that could separate the facepiece from the lens member.

49. The integrally molded lens member of claim 41 additionally including a nose cup to assist in directing the flow of air into and out of the face mask and with the nose cup located within the integrally molded lens member and mounted around the central portion integrally molded as part of the lens member and to communicate directly with the exhalation valve to provide for the direct exit of exhaust air and to communicate with the connector to receive an outside supply of air when the cheek apertures each hold a plug member to close off the cheek apertures.

50. The integrally molded lens member of claim 49 wherein the nose cup is integrally molded to include an air deflector portion and air ports and with the deflector portion deflecting and guiding incoming air towards the air ports.

51. The integrally molded lens member of claim 50 wherein the air deflector portion is configured to deflect the outside supply of air from the connector downward to the air ports located at a bottom portion of the nose cup to have the air supply pass between the nose cup and the lens member and to reenter an upper portion of the nose cup.
